(19) United States
(12) Patent Application Publication
(10) Pub. No.: US 2018/0229882 A1
(43) Pub. Date: Aug. 16, 2018

(54) Package Assembly With Reinforced Corners

(71) Applicant: Thomas Murdock Partridge, Inver Grove Heights, MN (US)

(72) Inventor: Thomas Murdock Partridge, Inver Grove Heights, MN (US)

(73) Assignee: Delkor Systems, Inc., St. Paul, MN (US)

(21) Appl. No.: 15/429,701

(22) Filed: Feb. 10, 2017

(51) Int. Cl. B65D 5/44; B65D 5/20; B65D 5/30; B65D 5/42

(52) U.S. Cl. CPC B65D 5/443; B65D 5/2085; B65D 5/302; B31B 1/62; B65D 5/4204; B31B 1/26; B65D 5/4266

(57) ABSTRACT

A tray formed of a single piece blank and which has reinforced corners to enable superior stacking capabilities and capacities is presented. The tray includes a base and four panels extending therefrom. Each panel has a major component extending from the base and a minor component extending from opposing sides of the major component. The minor components of the side panels consist of a tab and a freestanding portion. Only the tab is adhesively engaged to an interior surface of an immediately adjacent major component of and adjacent panel. The minor components of front and back panels being adhesively engaged to the major component of the side panels. The reinforced corners having a triangular shape defined by the major component and one minor component of the front panel or back panel and a hypotenuse consisting of one freestanding portion.

### FIELD OF THE INVENTION

Aspects of the present disclosure are directed to packaging trays for the storage, shipping and display of various products; and which have sufficient stacking strength so that several such trays may be stacked, one upon the other, without damage to the trays or the products positioned thereon or contained therein.

### BACKGROUND

Shipping packages, such as corrugated, cardboard and/or paperboard boxes, trays and similar assemblies are commonly used to contain a plurality of products or product containers for transport of such products from the manufacturer, to their eventual retail environment. Often times the products contained in such trays are relatively heavy and yet it is nevertheless desirable or necessary to stack such trays (with their products contained therein) one on top of the other.

Some examples of such reinforced trays are described in U.S. Pat. No. 5,535,941 to Garza and U.S. Pat. No. 6,719,191 to Christensen; the entire contents of both of which are incorporated herein by reference. As these references recognize, providing shipping trays with reinforced corners provides the tray, and columns of such stacked trays, with more vertical compression resistance and stability than a tray lacking such corner reinforcement. Some known drawbacks of such trays however include their relative fold complexity, such that the tray may require manual or “by hand” manipulation to complete its assembly; as well as their frequent use of multiple blank components as opposed to being constructed from a single blank.

Thus, a need exists to provide for a stackable shipping and packaging tray having reinforced corners and which is easy to assemble via high speed automation and which is made of a single blank of source material.

### SUMMARY

Embodiments of the present disclosure are constructed from a single piece of material into which a packaging tray is formed. By the shape of the source material (i.e. a blank) and the manner in which it is folded and assembled, the resulting packaging tray is provided with reinforced posts in each of its corners thereby providing the tray with additional stacking strength. Moreover, the unique shape of the blank allows the tray to be formed through the use of rapid automated assembly practices, without the need of any hand setup or manipulation that many known reinforced trays require for their assembly.

Embodiments of the tray described herein may be configured for shipping, stacking, displaying and/or packaging any products desired.

### BRIEF DESCRIPTION OF THE DRAWINGS

FIGS. 1a-1g depict a perspective view of a sequence of steps to assemble an embodiment of the tray shown in FIG. 1g from the blank of source material shown in FIG. 1a.

FIG. 2a is a perspective view of an embodiment of a blank.

FIG. 2b is a perspective view of an embodiment of a tray formed from the blank of FIG. 2a.

FIG. 3a is a perspective view of an embodiment of a blank.

FIG. 3b is a perspective view of an embodiment of a tray formed from the blank of FIG. 3a.

FIG. 4a is a perspective view of an embodiment of a blank.

FIG. 4b is a perspective view of an embodiment of a tray formed from the blank of FIG. 4a.

FIG. 5 is a perspective view of an embodiment of the tray with a cut-out front (display) panel with packages of product shown contained within the tray.

FIG. 6a is a perspective view of an embodiment of the tray with a cut-out panels and with packages of product shown contained within the tray.

FIG. 6b is a perspective view of the tray shown in FIG. 7a shown stacked upon a like tray.

FIG. 7a is a perspective view of an embodiment of the tray with a cut-out panels and with packages of product shown contained within the tray.

FIG. 7b is a perspective view of the tray shown in FIG. 7a shown stacked upon a like tray.

### DETAILED DESCRIPTION

As indicated above, embodiments of the packaging tray described herein are formed from a single piece of source material referred to hereinafter as a blank.

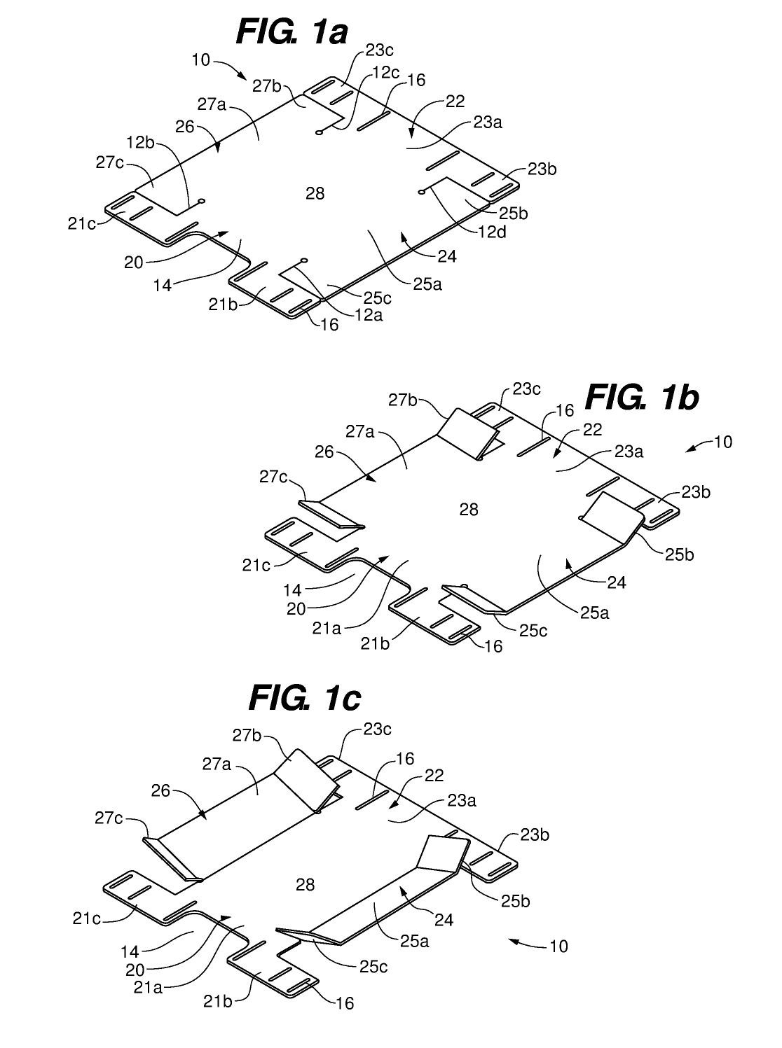

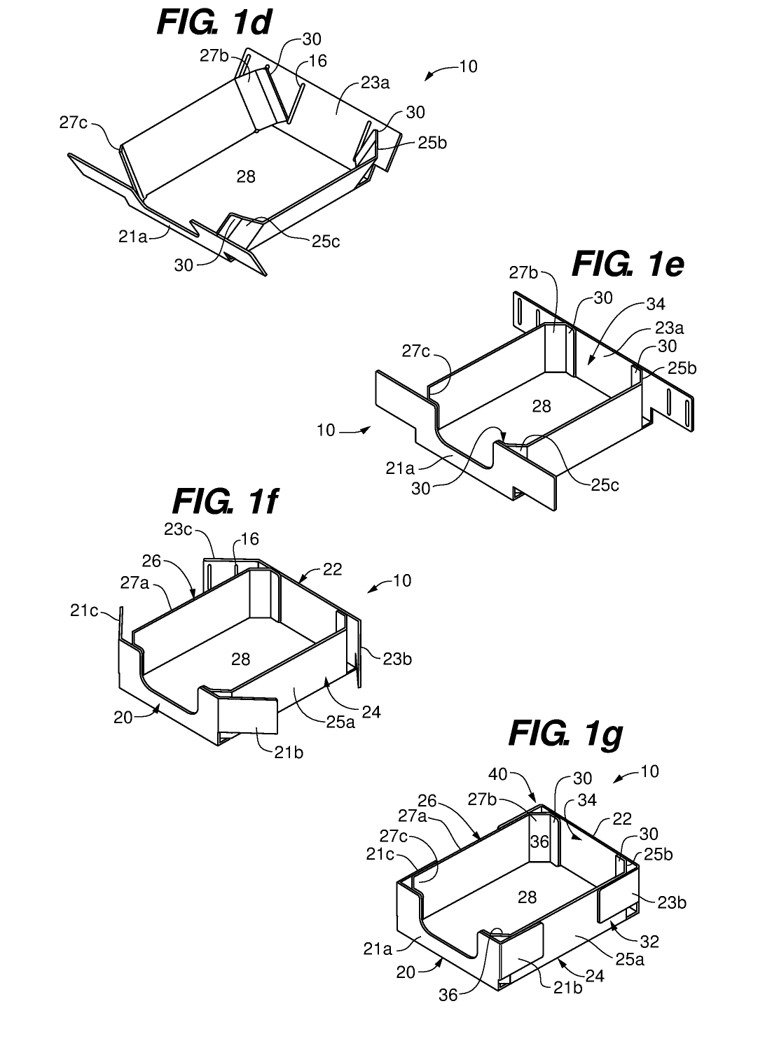

An example of a blank 10 is shown in the sequence of assembly steps shown in FIGS. 1a-1g which depict the manner in which the blank 10 is folded and assembled into a competed tray 100.

Blank 10, and thus tray 100, may be constructed of any material suitable for shipping and displaying containers. For example, the trays may be constructed from cardboard (corrugated or otherwise), press-board, chipboard, SBS board, wood, one or more paper product derivative, plastic, metal or other materials. Preferably, blank 10 is constructed from a light weight material that may be easily and inexpensively recycled or disposed of.

As shall be discussed in greater detail below, blank 10 may include various cut lines, cut-out areas or other features (perforations, tear-away sections, etc.) to provide for a wide variety of eventual tray configurations. In the embodiment depicted in FIG. 1a-1g however, the blank 10 is provided with four cut-lines 12a-d which act to separate and define segments of the blank form.

As depicted, those segments of the blank 10 includes a front panel 20 and a back panel 22 positioned opposite the front panel 20, and two opposing side panels: first side panel 24 and second side panel 26.

Each panel 20, 22, 24 and 26 is a continuous extension from a base panel 28. Each panel is comprised of a major component and two minor components, wherein the major component is that portion of the panel extending from the base 28 and the minor components extend from opposing sides of the major component and are at least partially defined by a cut-line and are immediately adjacent to a minor component of an adjacent panel, prior to folding the blank 10.

Thus: front panel 20 includes front panel major component 21a and two front panel minor components 21b and 21c. Back panel 22 includes back panel major component 23a and two back panel minor components 23b and 23c. First side panel 24 includes first side panel major component 25a and two first side panel minor components 25b and 25c. Second side panel 26 includes second side panel major component 27a and two second side panel minor components 27b and 27c.

As an example of the relationship between panels and components, as may be seen in FIG. 1a, prior to the blank being folded, front panel minor component 21c is bordered by second side panel minor component 27c and separated/defined by cut-line 12b. Minor component 27b is immediately adjacent to 23c with cut-line 12c defining their respective border. Minor component 23b is immediately adjacent to 25b with cut-line 12d defining their respective border. Minor component 25c is immediately adjacent to 21b with cut-line 12a defining their respective border.

Though the position of the elements shown in FIG. 1a and described above will move and shift relative to one another during the folding process shown in FIGS. 1b-1g, their relative proximities remain the same throughout the folding and tray assembly process.

In the embodiment shown in FIGS. 1a-1g, front panel 20 of the blank 10 includes a display region 14 which is an area of the panel 20 that is pre-shaped or cut-out of the panel 20 to provide a window or recess through which an observer may more readily see into the interior of the tray 100, such as is shown in FIG. 1g. Such a display region 14 may be provided to the panel 20 before the folding process or afterward. In some embodiments the panel 20 includes a perforation line (not shown) which bisects the panel 20 to allow a portion thereof to be torn away or otherwise removed to provide the desired display region 14. Such tear away portions of a blank or tray are well known and understood by those of ordinary skill in the art.

Turning now to the actual process of folding and assembling a tray 100 such as is shown in FIG. 1g, one step in the assembly is to provide the blank 10 shown in FIG. 1a, with several strategically located lines, spots, areas, etc. of adhesive 16 for subsequently bonding various of the aforementioned components of the blank 10 together.

Adhesive 16 may be any type of adhesive suitable for bonding the material of the blank 10 together. In at least one embodiment the adhesive 16 is a hot melt adhesive. With the adhesive properly deposited, such as in the manner shown, the folding process of the blank 10 may begin.

A first step in the folding process is depicted in FIG. 1b wherein it is shown that a force is applied to the minor components 25b and 25c of the first side panel 24 and to the minor components 27b and 27c of the second side panel 26 thereby causing these components to be pushed out of the plane defined by the blank 10. A force is then applied to the major components of the side panels 24 and 26 respectively, thereby causing the side panels 24 and 26 to likewise be pushed out of the plane defined by the base 28 of the blank 10 such as in the manner shown in FIG. 1c.

Turning to FIGS. 1d and 1e, the next step in the folding process is shown wherein the side panel minor components 25b, 25c and 27b, 27c are pushed or otherwise placed in proximity with the front panel major component 21a and the back panel major component 23a. The panels are manipulated in such a way that that portions or tabs 30 of components 25b and 27b are placed against regions of adhesive 16 that were pre-applied to the back panel major component 23a, and portions or tabs 30 of components 25c and 27c are placed against regions of adhesive 16 (not visible) that were pre-applied to the front panel major component 21a.

Following the initial adhesive engagement shown in FIG. 1e, the next step in the folding process is depicted in FIG. 1f, wherein the minor components 21b, 21c and 23b, 23c of the front panel 20 and rear panel 22, are folded or wrapped about and adhesively engaged to the major components 25a and 27a of the respective side panels 24 and 26 via the remaining unengaged adhesive areas 16.

This wrapping of the front panel minor components 21b and 21c about the minor components 25c and 27c of the respective side panels 24 and 26, as well as the back panel minor components 23b and 23c about the minor components 25b, 27b of the respective side panels 24 and 26; forms corner posts 40 visible in the completed tray 100 of FIG. 1g.

As may best be seen in FIG. 1g, when the blank 10 is fully assembled into tray 100, posts 40 are constructed from the interface and adherence of the front (21b and 21c) and back (25b and 27b) minor components against an exterior surface 32 of the major components (25a and 27a) of side panels 24 and 26; while tab portions 30 of the minor components (25b, 25c and 27b and 27c) of each side panel 24 and 26 are engaged to and adhered against an interior surface 34 of the major components 21a and 23a of the front panel 20 and back panel 22 respectively.

The resulting posts 40 thus include three intersecting surfaces of material in a triangular formation wherein the exterior elements of the triangle are comprised of the major and minor components of the respective front panel and back panel intersecting at a right angle (˜90 degrees) with the hypotenuse of the triangle being formed by a free standing portion 36 of each minor component (25b, 25c, 27b, 27c) of the side panels 24 and 26. Note “free standing portions” 36 are those portions of the side panel minor components adjacent to the tab 30 and extending from the major component.

As the sequence of images in FIGS. 1a-1g and the above description should make clear, the tray 100 is formed through the selective application of force to its component structures during the depicted folding sequence such as may be provided by passive or active tooling via single motion formation or other type of system. A key aspect of the present disclosure is to provide a blank 10 that may be folded/assembled into a tray 100 having reinforced posts 40 and without the need for hand or individual manipulation of the blank 10 or tray 100 during the automated folding/assembly process shown in FIGS. 1a-1g.

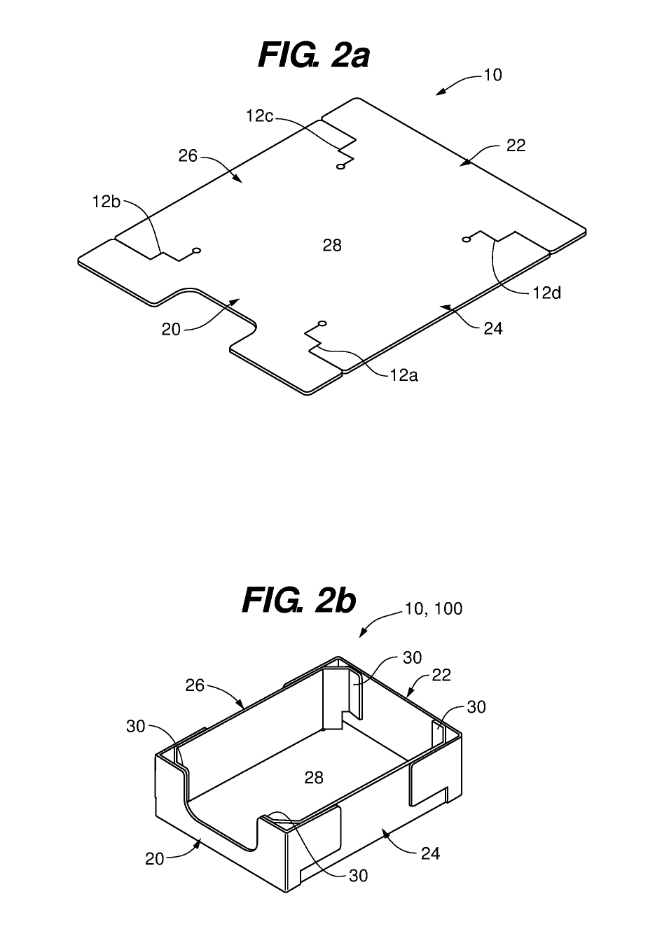

With that in mind, it will be apparent to those of skill in the art that variations in size, shape, and particular cut and fold arrangement are possible in both the blank 10 and tray 100. Some examples of such alternative configurations are shown in FIGS. 2a-6b.

Beginning with the embodiment shown in FIGS. 2a-2b, a blank 10 and tray 100 are shown wherein cut-lines 12a-d are shown provided in an example of an alternative pattern which results in tabs 30 being relatively short in length compared to the major components of the panels, 20, 22, 24 and 26. Such cut-line pattern is merely one of a variety of patterns they may be used to provide a tray 100 that uses less/more blank material, less/more adhesive, etc.

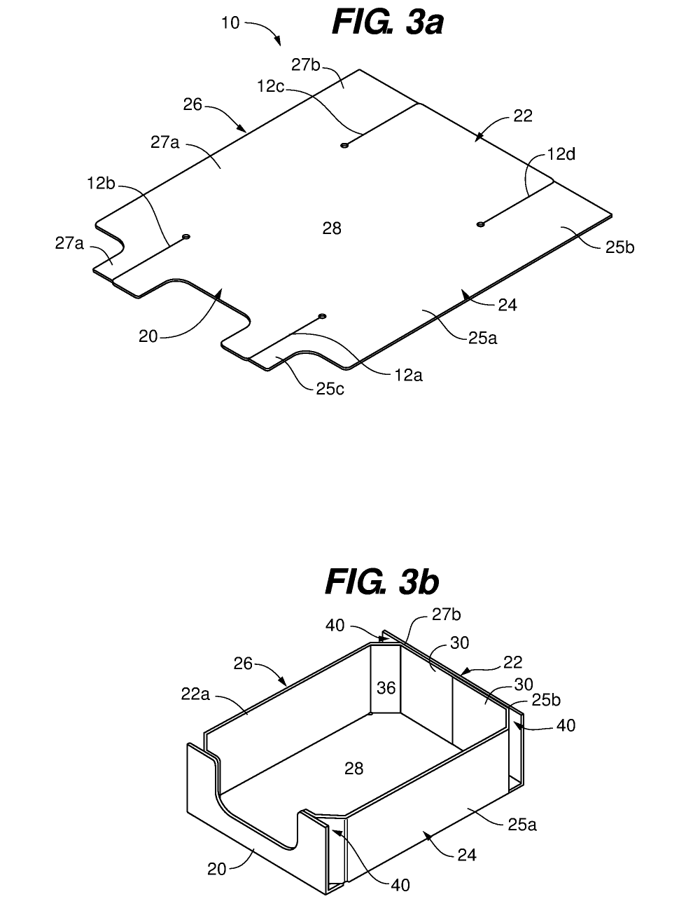

Another pattern and configuration are illustrated in FIGS. 3a-3b wherein a blank 10 is provided with single direction cut-lines 12a-12d. Which provides for a tray 100 having a variety of unique characteristics notably:

Side panel (24 and 26) minor elements 25c and 27c which are of a significantly reduced height relative to their respective major components 25a and 27a, this requiring significantly less adhesive when engaged to the front panel 20. Side panel (24 and 26) minor components 25b and 27b which are of a significantly greater surface area than those previously described, and thus providing a greater surface area upon which adhesive may be used to engaged the tab 30 portions of the components 25b and 27b to the back panel 22. Front panel 20 and back panel 22 lacking minor components all together to provide posts 40 of two intersecting elements, rather than the arrangement of three triangular elements previously described. Such an embodiment is more suited for lighter duty/weight use but which nevertheless may require staking of multiple trays 100.

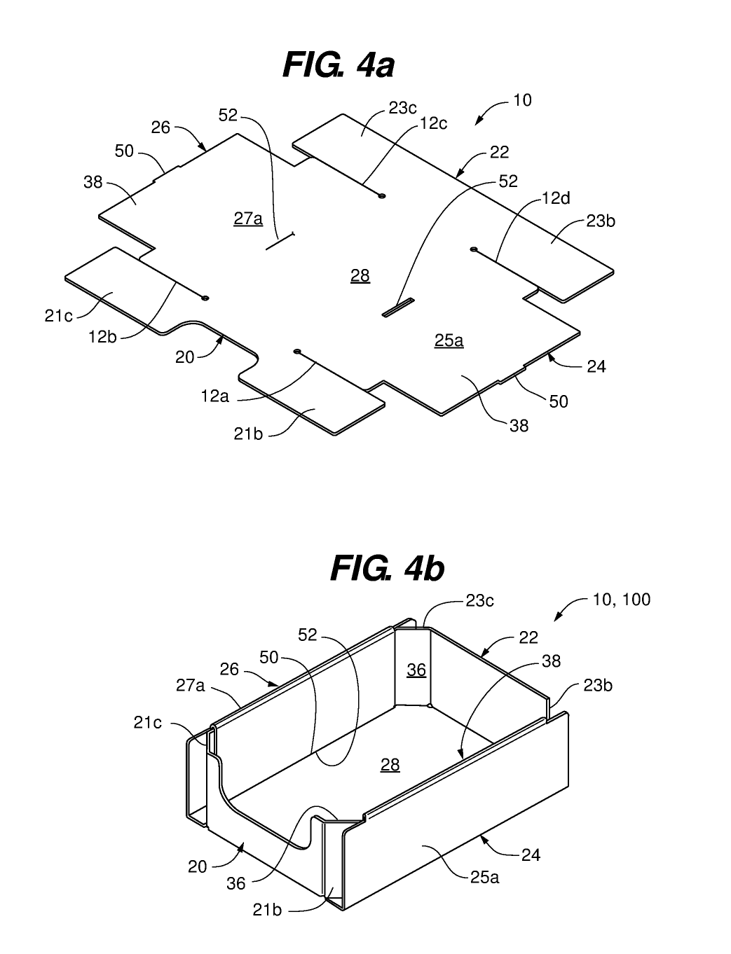

As a variation to that which is described above, in the embodiment shown in FIGS. 4a-4b a blank is shown wherein the cut-lines 12a-12b are also single direction lines but by being offset 90 degrees to those shown in FIGS. 3a-3b, provide a very different tray 100 using a different shape blank 10. In the present embodiment of FIGS. 4a-4b front panel 20 and rear panel 22 both have relatively elongated minor components (21b, 21c and 23b, 23c) for internal engagement of the side panels 24 and 26. The side panels 24 and 26 however lack minor components and instead include an internal flap 38 which folds over the major components 25a and 27a respectively of each side panel 24 and 26 to form a sandwich over the respective minor components (21b, 21c and 23b, 23c) of the front panel 20 and rear panel 22.

The side panel internal flaps each include a tab 50 which is sized and shaped for complementary receipt and engagement to slot opening 52 which is defined by the base 28. By such an arrangement the present embodiment provides a tray 100 that may entirely avoid the need or use of adhesive for securing components together.

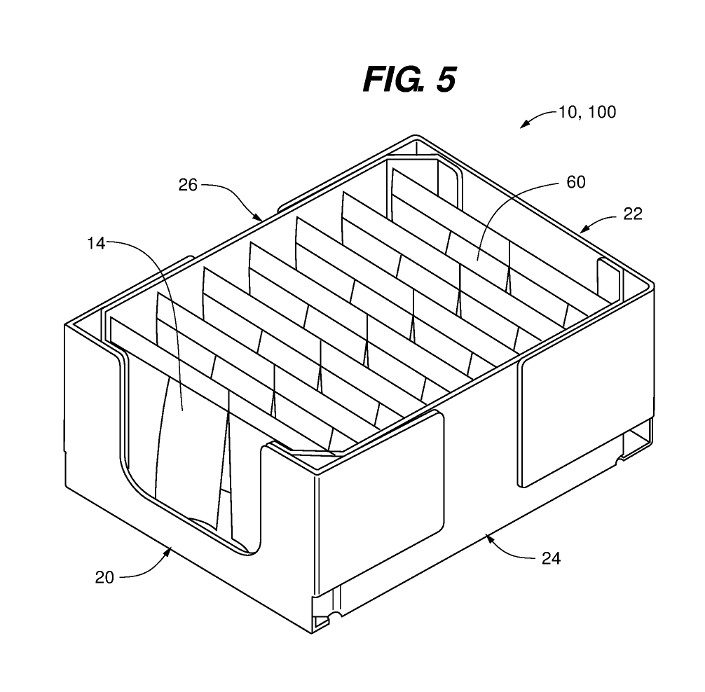

Turning now to FIG. 5, an embodiment of the tray 100, corresponding to that shown in FIG. 1g is shown, but with product packages 60 shown contained within the tray interior (the area provided between the panels 20, 22, 24, 26 and upon the base 28 (base not visible)). As previously mentioned, in the embodiment shown front panel 20 includes a cut-out or display window 14 through which the product packages 60 contained within the tray 100 are readily visible.

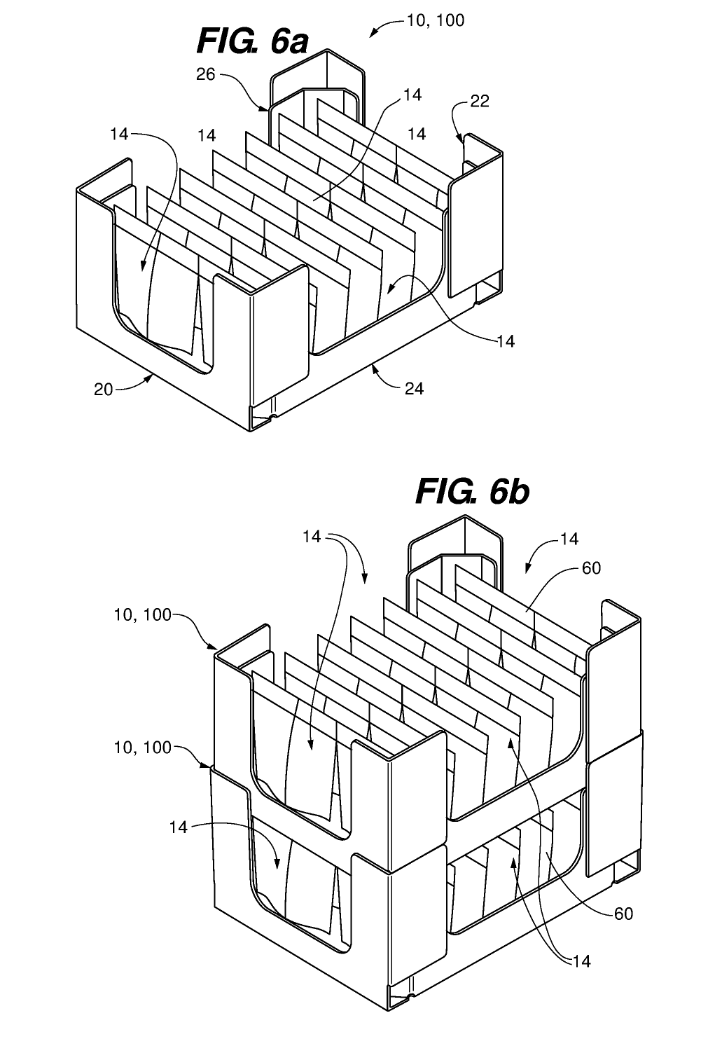

Display windows 14 may be incorporated into more than one panel. For example, in the embodiment shown in FIG. 6a all four panels 20, 22, 24 and 26 are provided with a display window 14 which allows packages 60 to be readily visible and accessible from all for sides of the tray 100, even when multiple trays 100 are stacked upon one another such as in the manner shown in FIG. 6b.

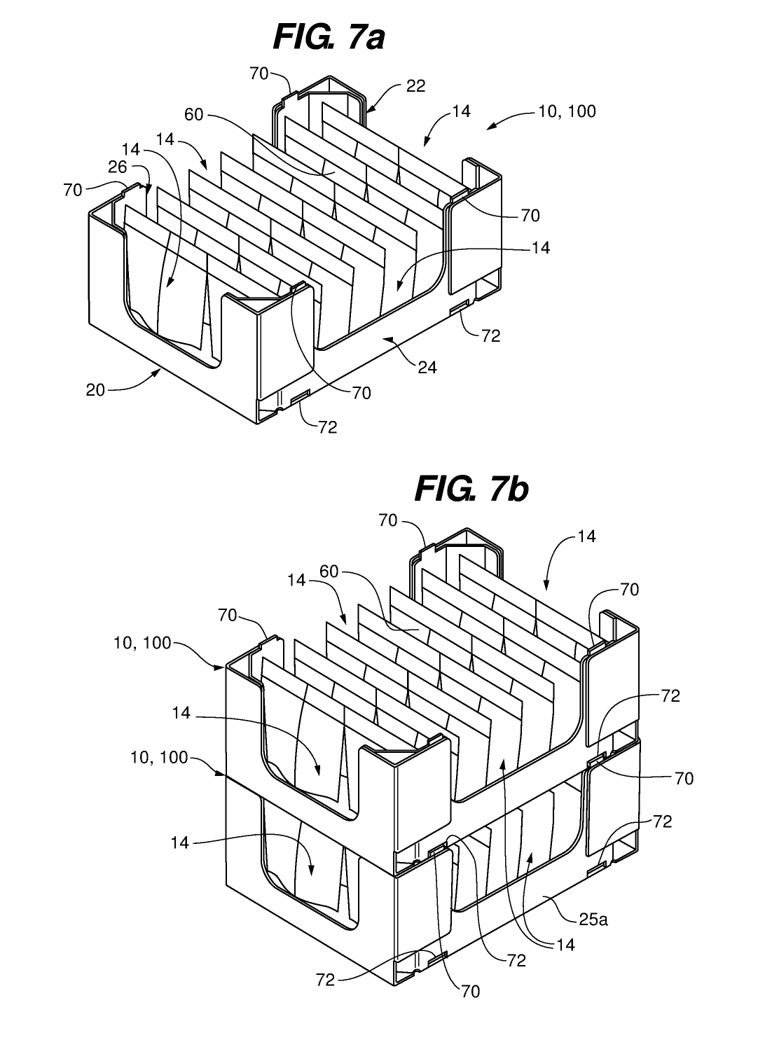

In regard to stacking the trays 100, in some embodiments, an example of which is shown in FIGS. 7a-7b, any or all of the various panels 20, 22, 24, 26 (and their elements) may be provided with one or more vertically extending tabs or protrusions 70 for engagement with correspondingly shaped recesses or openings 72 of an adjacent tray. Such openings 72 may be present in and defined by the base 28 and or the panels 20, 22, 24, 26.

In the present embodiment, openings 72 are defined by the major component 25a and 27a (not visible) of the respective side panels 24 and 26; with each component 25a and 27a having two openings 72 positioned to receive two vertically extending protrusions 70 positioned on the opposing surface of each component 25a and 27a of an adjacent tray 100 in the manner shown in FIG. 7b.

Any combination or variety of openings 72 and protrusions 70 may be provided to the tray 100 for purposes of providing improved stacking stability and to secure such stacked trays from incidental translational moment during shipping, storage or display.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A tray having reinforced corners, the tray comprising:
a base, the base having four panels extending therefrom, the four panels comprising a front panel and back panel, a first side panel and a second side panel;
each panel having a major component extending from the base and a minor component extending from opposing sides of the major component;
the minor components of each side panel consisting of a tab and a freestanding portion, only the tab being adhesively engaged to an interior surface of an immediately adjacent major component of the front panel or back panel;
the minor components of the front panel and back panel being adhesively engaged to the major component of one of the first side panel and the second side panel respectively;
the reinforced corners each having a triangular shape wherein two sides of the triangular shape are formed by a portion of the major component and one minor component of the front panel or back panel, and a hypotenuse of the triangular shape consisting of one freestanding portion.

2. The tray of claim 1, constructed from a blank, the blank being a single piece of material.

3. The tray of claim 2, wherein the blank defines a plurality of cut-lines, each cut-line at least partially defining one of the minor components of one of the side panels and one of the minor components of one of the front panels or back panels.

4. The tray of claim 2, wherein at least one of the four panels defines a display window.

5. The tray of claim 2, further comprising a plurality of protrusions, each protrusion extending vertically from at least one of the four panels.

6. The tray of claim 5, further comprising a plurality of openings, wherein each opening is defined by a portion of the blank, each opening positioned in vertical opposition to one of the plurality of protrusions, each protrusion and each opening having a corresponding size and shape.

7. A method of forming a tray having reinforced corners, the method comprising:
providing a single piece blank of material, the blank having a base that defines a plane and four panels extending from the base within the plane, the panels comprising a front panel and back panel, a first side panel and a second side panel, each panel having a major component extending from the base and a minor component extending from opposing sides of the major component;
applying discrete quantities of adhesive to selected portions of the front panel and back panel;
moving the minor components of the first side panel and the second side panel out of the plane;
moving the major components of the first side panel and the second side panel out of the plane;
moving the front panel and back panel out of the plane;
adhesively engaging the minor components of the first side panel and second side panel to the major components of the front panel and back panel respectively;
adhesively engaging the minor components of the front panel and back panel to the major components of the first side panel and second side panel respectively.

8. The method of claim 7, wherein the minor components of each side panel consist of a tab and a freestanding portion and only the tab is adhesively engaged to an interior surface of an immediately adjacent major component of the front panel or back panel.

9. The method of claim 8, wherein following adhesively engaging the minor components of the front panel and back panel to the major components of the first side panel and second side panel respectively the try having reinforced corners is formed, each reinforced corner having a triangular shape wherein two sides of the triangular shape comprise a portion of the major component and one minor component of the front panel or back panel, a hypotenuse of the triangular shape consisting of one freestanding portion.
